(19) United States
(12) Patent Application Publication
(10) Pub. No.: US 2004/0128915 A1
(43) Pub. Date: Jul. 8, 2004

(54) Door for automated machine

(76) Inventors: Jean-Francois Garin, Lyon (FR); Laurent Miranda De Azevedo, Lyon (FR)

Correspondence Address: CLARK & BRODY, 1750 K STREET NW, SUITE 600, WASHINGTON, DC, 20006, US

(21) Appl. No.: 10/691,658

(22) Filed: Oct. 24, 2003

(30) Foreign Application Priority Data
Oct. 25, 2002 (FR) 02 13 363

(51) Int. Cl. E05D 15/28; E05D 15/40

(52) U.S. Cl. 49/246

(57) ABSTRACT

The door for an automated machine comprises a chassis (6) delimiting an opening (7) and equipped with guide means for the movement of at least one mobile panel (10, 11), between a closed position in which the façade (14) of the mobile panel (10) at least partly closes the opening (7) and an open position in which the mobile panel (10) is located laterally with respect to the opening (7).

According to the invention, the mobile panel (10) comprises:

a reception structure (12) for a man-machine interface (13) for which the façade is accessible when the mobile panel is in the closed position,

and reception structure displacement means (12) assuring that when the mobile panel is in the open position, the façade (14) of the man-machine interface (13) is moved towards the opening (7) so that an operator in position in front of the opening can access the opening and the man-machine interface (13) at the same time.

The technical domain of the invention relates to doors designed to close access to a machine in the general sense.

Said invention is particularly applicable to a door fitted on an automated machine, for example such as a machine tool, a handling machine, an inspection machine, etc.

There is a frequent need in the industrial domain to equip a machine with protective cladding composed of rigid partitions installed on the machine frame, for safety or tidiness reasons. Said protective cladding is equipped with a door with one or several mobile panels providing access to the machine. Thus, in the example embodiment described in European patent application 0 606 560, each door is composed of two mobile panels provided with sliding and pivoting guide means for folding panels adjacent to each other in the open position of the door.

Moreover, it appears that the different functions of the machine are controlled by a device usually called a man-machine interface and for example installed on the protective cladding of the machine. Said man-machine interface is positioned such that an operator can use it when the door is in the closed position. However, when the access door is opened, it frequently arises that the man-machine interface is difficult to access by an operator who would like to use the interface and access the machine at the same time.

In the state of the art, it is known that the man-machine interface can be fitted on a mobile carriage placed adjacent to the machine or on a mobile arm supported by the machine frame. Although said type of solution does have the advantage that the man-machine interface can be used at the same time as the machine is being accessed, there is no doubt that the carriage or the mobile arm clutters the machine environment both when the door is opened and when it is closed.

The Applicant made an analysis of previous known solutions and realised that there is a need to have a man-machine interface that does not clutter the machine environment and that an operator can use while accessing the machine when the door is in the open position.

Therefore, said invention is intended to satisfy said need by suggesting a solution by which an operator can access a machine at the same time that he is using a man-machine interface which in any case is not a hindrance in the machine environment.

Therefore, the purpose of said invention is a door for an automated machine comprising a chassis delimiting an opening and equipped with guide means for the movement of at least one mobile panel, between a closed position in which the façade of the mobile panel at least partly closes the opening, and an open position in which the mobile panel is located laterally with respect to the opening. The mobile panel according to the invention comprises:

a reception structure for a man-machine interface for which the façade is accessible when the mobile panel is in the closed position,

and reception structure displacement means assuring that when the mobile panel is in the open position, the façade of the man-machine interface is moved towards the opening so that an operator in position in front of the opening can access the opening and the man-machine interface at the same time.

According to a first variant of embodiment, the reception structure displacement means are composed of displacement guide means that slide and pivot the mobile panel, thus ensuring that the mobile panel façade is facing the opening when the mobile panel is in the open position.

According to a second variant of embodiment, the reception structure displacement means are composed of means capable of pivoting the man-machine interface ensuring that the façade of the man-machine interface is accessible when the mobile panel is in the closed position or the open position.

Thus, the displacement guide means enable the façade of the man-machine interface to move into a plane approximately perpendicular to the plane delimited by the opening.

According to an example embodiment, the displacement guide means enable the façade of the man-machine interface to move into a plane forming an angle with the plane delimited by the opening, equal to between 40° and 135°, and preferably between 60 and 110°.

According to one embodiment for which the guide means slide and pivot the mobile panel, these guide means consist of at least one support and guide rail for at least one roller device fitted on the mobile panel, the mobile panel being connected by a pivot to an extension bar guided in translation along a direction approximately perpendicular to the opening.

According to another embodiment in which there is one door with two mobile panels, the sliding and pivoting guide means consist of at least one support and guide rail for at least one roller device fitted on a first mobile panel hinged to a second mobile panel installed hinged on the chassis, the mobile panels being intended to fold in contact with each other in the open position of the opening.

For example, the sliding and pivoting guide means comprise a support and guide rail called the upper rail arranged in the top part of the chassis and a guide rail called the lower rail arranged in the lower part of the chassis, one supporting the roller device(s), fitted on the mobile panel, and the other supporting a guide device.

Advantageously, the mobile panel is fitted with a man-machine interface containing machine instrumentation and/or control means.

Various other characteristics will become clear after reading the description given below with reference to the attached drawings that show different embodiments of the object according to the invention as non-limitative examples.

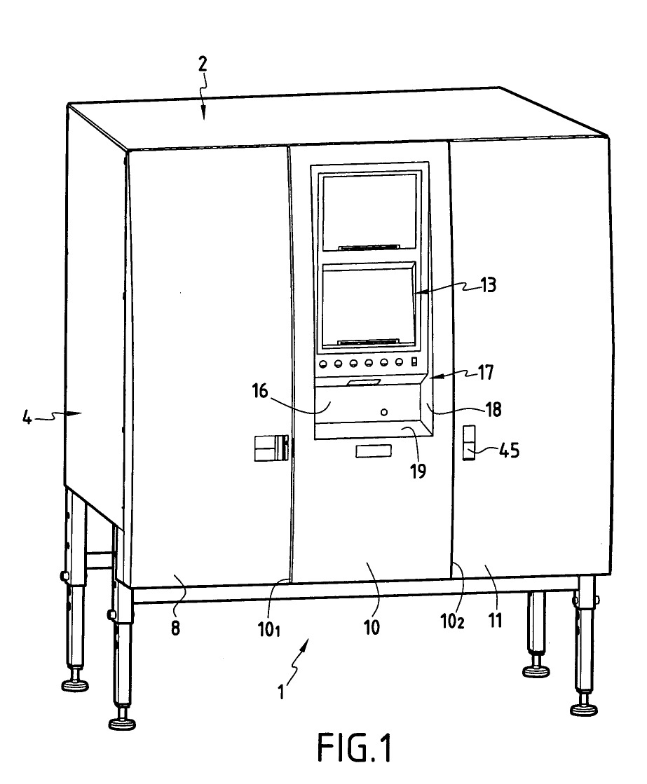

FIG. 1 is a perspective view showing a door according to the invention in the closed position, fitted on the machine.

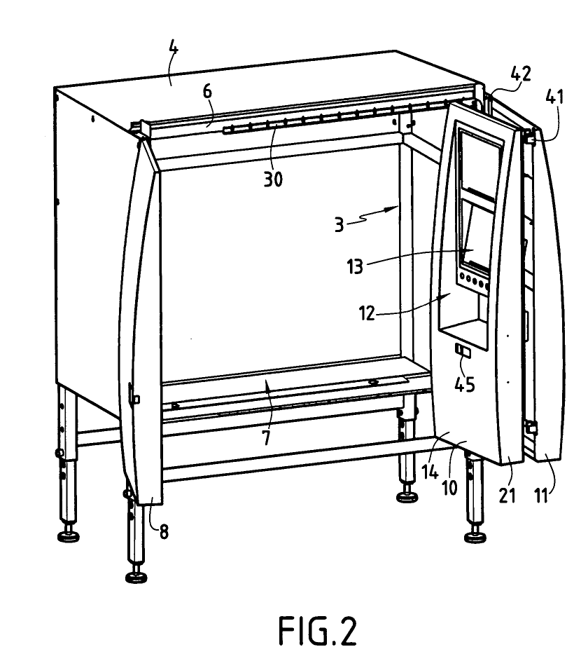

FIG. 2 is a view similar to FIG. 1 illustrating a machine equipped with a door according to the invention, in the open position.

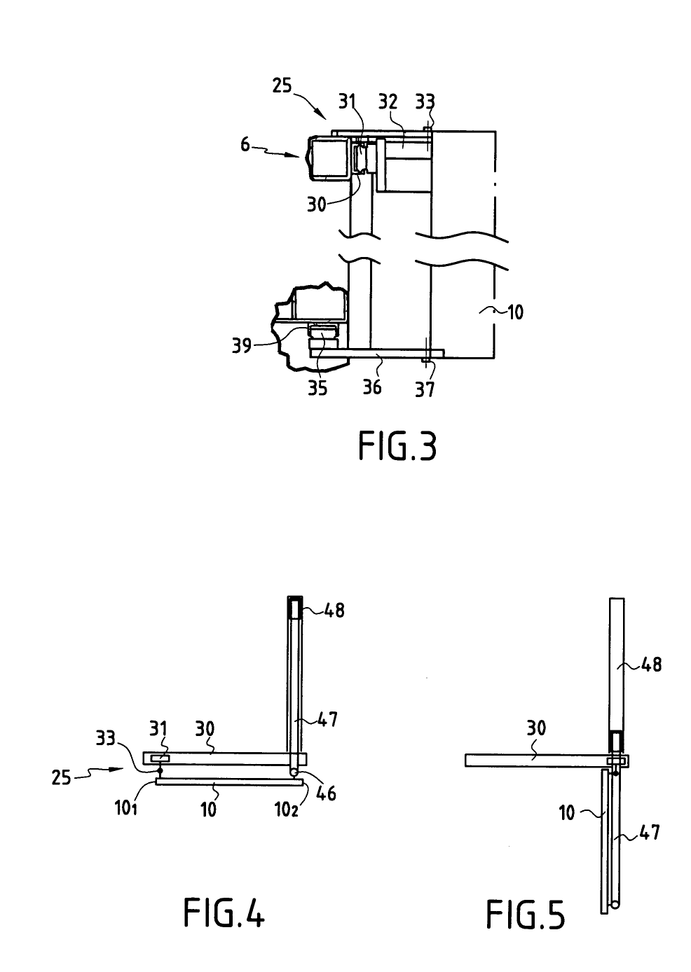

La FIG. 3 is a partial cross-sectional view in elevation showing the assembly of a door according to the invention.

FIGS. 4 and 5 are diagrammatic views showing another example of embodiment of an access door comprising a single mobile panel.

As is quite clear from FIGS. 1 to 3, the purpose of the invention relates to a door 1 that will be fitted on a machine 2 in the general sense of the word, for example such as a machine tool, a handling machine, a checking machine, etc. In one preferred example of embodiment, the machine 2 is an automated machine in which several receptacles can move in front of different checking or inspection stations.

Conventionally, the machine 2 comprises a frame 3 that has a parallelepiped shape in the example illustrated. Said frame 3 is provided with protective cladding 4 composed of side, bottom and top panels. In the façade of the machine 1, there is a chassis 6 delimiting an opening 7 accessing the internal volume of the machine 1. Said opening 7 is opened or closed using a door 1 conform with the invention, in the example illustrated associated with a pivoting leaf 8. In the example of embodiment illustrated in FIGS. 1 to 3, the door 1 comprises a first mobile panel 10 installed hinged to a second mobile panel 11.

According to one characteristic of the invention, the first mobile panel 10 comprises a reception structure 12 for a man-machine interface 13 comprising various instrumentation and/or control means for controlling the machine. Said man-machine interface 13 comprises for example a keyboard, a screen, a control desk, a mouse, etc. Said man-machine interface 13 is provided with a façade that is easily accessible from the façade 14 in the first mobile panel 10 when it is in the closed position of the opening (FIG. 1).

As is quite clear in FIG. 2, the thickness of the first mobile panel 10 is preferably such that the man-machine interface 13 can be installed. Consequently, the first mobile panel 10 has a back wall 16 and the façade wall 14 is at a distance from said back wall, and at least one housing 17 delimited by the side plates 18 connected to a horizontal bearing wall 19 is formed in said façade wall. The housing 17 enables the assembly of the various components of the man-machine interface 13. The back wall 16 is connected to the façade wall 14 through two outer sides 21 such that the first mobile panel 10 forms a closed box within the thickness of which the man-machine interface 13 is installed.

According to another characteristic of the access door 1, the chassis 6 is fitted with displacement guide means 25 for the mobile panels 10, 11 so as to move the mobile panels between a closed position in which the façade 14 of the first mobile panel 10 at least partly closes the opening 7 (FIG. 1) and an open position in which the mobile panels 10, 11 extend laterally from the opening 7.

According to another characteristic of the invention, the mobile panel 10 comprises reception structure displacement means 12, adapted so that when the mobile panel is in the open position, the façade of the man-machine interface 13 is facing towards the opening so that an operator in position in front of the opening 7, can access the opening and at the same time access the man-machine interface 13 (FIG. 2). Therefore, it must be considered that when the door is in the closed position, an operator can access the man-machine interface 13 without said interface taking up any space surrounding the machine 1. When the opening 7 is in the open position, an operator in front of the opening can access the man-machine interface 13 while viewing the inside of the machine without changing position, so that for example he can observe the result of controls made using the man-machine interface 13 at the same time. Furthermore, there is no limit on access to the opening 7, except for the thickness of the mobile panels 10, 11.

In the preferred embodiment shown on the drawings, the reception structure displacement means 12 are composed of means 25 capable of guiding movements of the mobile panel that slide and pivot the mobile panel 10 such that when the mobile panel is in the open position, the façade 14 of the mobile panel is facing the opening 7.

In the example of embodiment as shown in FIGS. 1 to 3 in which there is one door 1 with two mobile panels 10, 11, the sliding and pivoting guide means 25 consist of at least one support and guide rail 30 installed on the chassis 6. As shown in the example of embodiment, a rail 30 called the upper rail is installed on a longitudinal cross beam on the chassis 6. The upper rail 30 has a “C” shaped prismatic cross-section and acts as a guide and support rail for a roller device 31 such as a wheel for example. The roller device 31 is connected to a tab 32 installed around a pivot 33, in the top part of the first mobile panel 10 at its free vertical end 101. The first mobile panel 10 is also equipped with a guide device 35 supported by a tab 36 installed on a pivot 37 in the bottom part of the first mobile panel 10 at its free vertical end 101. The guide device 35 is installed inside a rail 39 called the lower rail, supported by a longitudinal cross beam on the chassis 6. For example, the lower rail 39 has a <<U>> shaped prismatic transverse section.

Therefore in the above description, the first mobile panel 10 is suspended from the upper rail 30 while the lower rail 39 cooperating with the guide device 35 prevents rotation of the first mobile panel 10. Obviously, it would be possible to invert the position of the roller device 31 and the guide device 35 or to use two roller devices 31, 35 for support and guidance of the first mobile panel 10.

The first mobile panel 10 is installed hinged at its vertical end 102 opposite the free vertical end 101 by hinges 41 on a side of the second mobile panel 11 which is also installed hinged on the chassis 6 at its opposite side by axes 42. Therefore the second mobile panel 11 is installed hinged at one end to the chassis 6 along a vertical direction passing through the axes 42 and at the other end to the first mobile panel 10 also along a vertical direction passing through the hinges 41.

As is clear from the above description, the mobile panels 10 and 11 can close the opening 7 when they are in the deployed position. In said position, the front walls of the panels 10 and 11 are positioned in line with each other and are facing outwards from the machine 1. When work has to be done on the machine 1, the door 1 is opened by pulling on at least one handle 45 for example located on the second mobile panel 11 so as to fold the two mobile panels 10, 11 so that the first mobile panel 10 is folded in contact with the second mobile panel 11 with their inner or bottom faces facing each other. In said position, the mobile panels 10, 11 are approximately perpendicular to the opening 7 with the façade 14 of the first mobile panel 10 turned or oriented towards the opening 7. The door 1 is moved from its open position to its closed position by taking the opposite steps, for example applying a tension force on the first mobile panel 10 starting from a handle 45 to make it move along the guide rails 30, 39.

FIGS. 4 and 5 show another variant of embodiment of the sliding and pivoting guide means 25 for an access door 1 comprising a single mobile panel 10. According to said variant of embodiment, the guide means 25 are composed preferably of at least one upper support and guide rail 30 and one lower support and guide rail 39 as described above, for rolling devices 31 and guide devices 35 installed on pivots 33, 37 on a vertical end 10₁ of the mobile panel 10. The other vertical end 10₂ of the mobile panel 10 connected by pivots 46 at its top and its bottom, to two extension bars 47 each guided in translation in a slide 48 fixed along a direction approximately perpendicular to the opening 7.

A tension force on the mobile panel 10 makes the roller device 31 and the guide device 35 slide on the rails 30, 39 simultaneously making the extension bars 47 extend so that the mobile panel 10 can be pivoted so that at the end of its movement distance, it is approximately perpendicular to the opening 7. The opening 7 is closed by making a movement of the mobile panel 10 in the inverse direction.

In the preferred embodiment described above, the reception structure displacement means 12 are composed of door displacement guide means so that the man-machine interface 13 can be positioned such that the façade is accessible equally well in open and closed positions of the door. Note that the reception structure displacement means 12 may consist of reception structure pivoting means 12 such that the façade of the man-machine interface 13 is accessible in the closed and open positions of the mobile panel. In other words, these pivoting means provide a means of moving the façade of the man-machine interface 13, to the back of the mobile panel 10 so that the façade is facing the opening 7.

As will be clear from the above description, the displacement guide means are adapted so as to bring the façade of the man-machine interface 13 in the open position, into a position allowing access to the opening 7 and to the man-machine interface 13. In the open position, the mobile panel 10 is located laterally or on the side of the opening 7. In the example shown, the displacement guide means enable the façade of the man-machine interface 13 to move into a plane approximately perpendicular to the plane delimited by the opening 7 when the mobile panel 10 is in the open position. In other words, these displacement means enable the façade of the man-machine interface 13 to move into a plane forming an angle with the plane delimited by the opening 7, equal to between 40° and 135°, and preferably between 60° and 110°, when the mobile panel is in the open position.

Advantageously, the mobile panel 10 is locked in its open and close positions by any appropriate means.

1- Door for an automated machine, comprising a chassis (6) delimiting an opening (7) and equipped with guide means for the movement of at least one mobile panel (10, 11), between a closed position in which the façade (14) of the mobile panel (10) at least partly closes the opening (7) and an open position in which the mobile panel (10) is located laterally with respect to the opening (7), characterised in that the mobile panel (10) comprises:
a reception structure (12) for a man-machine interface (13) for which the façade is accessible when the mobile panel is in the closed position,
and reception structure displacement means (12) assuring that when the mobile panel is in the open position, the façade (14) of the man-machine interface (13) is moved towards the opening (7) so that an operator in position in front of the opening can access the opening and the man-machine interface (13) at the same time.

2- Door according to claim 1, characterised in that the reception structure displacement means (12) are composed of displacement guide means (25) that slide and pivot the mobile panel (10, 11) thus ensuring that the mobile panel façade (14) is facing the opening (7) when the mobile panel is in the open position.

3- Door according to claim 1, characterised in that the reception structure displacement means (12) are composed of means capable of pivoting the reception structure (12) of the man-machine interface such that the façade of the man-machine interface (13) is accessible when the mobile panel is in the closed position or the open position.

4- Door according to claim 1, characterised in that the displacement guide means enable the façade of the man-machine interface to move into a plane forming an angle with the plane delimited by the opening (7) equal to between 40° and 135°, and preferably between 60° and 110°.

5- Door according to claim 1 or 4, characterised in that the displacement guide means enable the façade of the man-machine interface to move into a plane approximately perpendicular to the plane delimited by the opening (7).

6- Door according to claim 1, characterised in that the guide means (25) slide and pivot a mobile panel (10) and consist of at least one support and guide rail (30) for at least one roller device (31) fitted on the mobile panel (10), the mobile panel being connected by a pivot (46) to an extension bar (47) guided in translation along a direction approximately perpendicular to the opening.

7- Door according to claim 1, characterised in that the sliding and pivoting guide means (25) consist of at least one support and guide rail (30) for at least one roller device (31) fitted on a first mobile panel (10) hinged to a second mobile panel (11) installed hinged on the chassis, the mobile panels (10, 11) being intended to fold in contact with each other in the open position of the opening.

8- Door according to claim 6 or 7, characterised in that the sliding and pivoting guide means (25) comprise a support and guide rail called the upper rail (30) arranged in the top part of the chassis (6) and a guide rail called the lower rail (39) arranged in the lower part of the chassis, one supporting the roller device(s), fitted on the mobile panel, and the other supporting a guide device (35).

9- Door according to claim 1, characterised in that the mobile panel (10′₁) is fitted with a man-machine interface (13) containing machine instrumentation and/or control means.

10- Automated machine characterised in that it comprises a door (1) conform with one of claims 1 to 9.
